(19) United States
(12) Patent Application Publication
(10) Pub. No.: US 2016/0312971 A1
(43) Pub. Date: Oct. 27, 2016

(54) VEHICLE LIGHTING FIXTURE

(71) Applicant: Stanley Electric Co., Ltd., Tokyo (JP)

(72) Inventors: Masanari TSUKADA, Tokyo (JP); Yuya TAKAHASHI, Tokyo (JP)

(21) Appl. No.: 15/135,422

(22) Filed: Apr. 21, 2016

(30) Foreign Application Priority Data
Apr. 22, 2015 (JP) 2015-087357

(51) Int. Cl. F21S 8/10; B60Q 1/06; F21V 17/12

(52) U.S. Cl. CPC F21S 48/1305; F21V 17/12; F21S 48/115; B60Q 1/06; F21Y 2101/02

(57) ABSTRACT

A vehicle lighting fixture can reduce the parts number to reduce the cost as well as achieve weight reduction. The vehicle lighting fixture can include an LED having an optical axis, an ADB reflector configured to hold the LED, and a bracket configured to hold and fix the ADB reflector so that the ADB reflector can rotate around a boss of the bracket parallel to the optical axis of the LED. The ADB reflector can include a hook, and the bracket can have a guiding hole formed therein, so that the hook is engaged with the guiding hole. The ADB reflector can have an elongated screw-insertion hole formed therein, and the bracket can include a screw boss formed therein. The ADB reflector can be fixed to the bracket by screwing, into the screw boss of the bracket, a screw to be inserted to the screw-insertion hole.

This application claims the priority benefit under 35 U.S.C. §119 of Japanese Patent Application No. 2015-087357 filed on Apr. 22, 2015, which is hereby incorporated in its entirety by reference.

### TECHNICAL FIELD

The presently disclosed subject matter relates to a vehicle lighting fixture with an optical axis, including a bracket and a reflector holding a light source so that the optical axis of the vehicle lighting fixture can be adjusted by rotating the reflector relative to the bracket.

### BACKGROUND ART

Common vehicle lighting fixtures such as a headlight to be disposed on either side of a vehicle front portion can include an aiming mechanism configured to adjust its optical axis. FIG. 1 is a cross-sectional view illustrating one example of such a vehicle lighting fixture including an aiming mechanism as illustrated in Japanese Patent Application Laid-Open No. 2014-063603.

The vehicle lighting fixture 101 in FIG. 1 includes an LED 102 serving as a light source, a reflector 103, a first attachment member 104 configured to support the LED 102 and the reflector 103, a second attachment member 105 configured to hold the lower end part of the first attachment member 104 so that the first attachment member 104 can be vertically inclined around a pivot shaft 106, and a housing 107 configured to hold the lower end part of the second attachment member 105 so that the second attachment member 105 can be vertically inclined around a pivot shaft 108. Further included are an adjustment nut 109 fixed to the upper part of the first attachment member 104 and an adjustment bolt 110 screwed to the adjustment nut 109 while being inserted through the second attachment member 105. Still further included are an adjustment nut 111 fixed to the upper part of the second attachment member 105 and an adjustment bolt 112 screwed to the adjustment nut 111 while being inserted through the housing 107.

With this configuration, when the adjustment bolt 110 is turned in an assembling process of the vehicle lighting fixture 101, the first attachment member 104 together with the LED 102 and the reflector 103 attached thereto as a unit can be vertically inclined around the pivot shaft 106, so that the optical axis of the unit can be adjusted in the vertical direction. After the vehicle lighting fixture 101 is assembled to be a final product, when the adjustment bolt 112 is turned, the second attachment member 105 together with the first attachment member 104 with the LED 102 and the reflector 103 attached thereto as a unit can be vertically inclined around the pivot shaft 108, so that the optical axis of the unit can be adjusted in the vertical direction. Note that the vehicle lighting fixture 101 can have a not-illustrated horizontal aiming mechanism similar to the aforementioned aiming mechanism so as to adjust the optical axis thereof in a lateral (horizontal) direction.

The vehicle lighting fixture 101 illustrated in FIG. 1 and proposed by, for example, Japanese Patent Application Laid-Open No. 2014-063603 requires multiple parts such as the adjustment nuts 109 and 111 and the adjustment bolts 110 and 112 even for the optical axis adjustment in the vertical direction, resulting in increased parts number, and cost increase and increased weight accordingly.

### SUMMARY

The presently disclosed subject matter was devised in view of these and other problems and features in association with the conventional art. According to an aspect of the presently disclosed subject matter, a vehicle lighting fixture can reduce the parts number to thereby reduce the cost as well as achieve weight reduction.

According to another aspect of the presently disclosed subject matter, a vehicle lighting fixture can include a light source having an optical axis, a reflector configured to hold the light source, and a bracket configured to hold and fix the reflector so that the reflector can rotate around an axis parallel to the optical axis of the light source.

With the vehicle lighting fixture having the aforementioned configuration, the rotation of the reflector relative to the bracket around the axis parallel to the optical axis of the light source can achieve optical axis adjustment without use of various additional parts such as an adjustment nut and an adjustment bolt. As a result, the vehicle lighting fixture can reduce the parts number to thereby reduce the parts cost as well as achieve weight reduction.

In another aspect of the vehicle lighting fixture with the aforementioned configuration, the reflector can include an engaging member such as a hook, and the bracket can have a guiding hole formed therein, so that the engaging member can be engaged with the guiding hole.

With the vehicle lighting fixture having the aforementioned configuration, since the engaging member, such as a hook, formed in the reflector can be engaged with the guiding hole formed in the bracket, the reflector can be prevented from dropping off the bracket while the rotation of the reflector can be allowed to achieve the optical axis adjustment.

In still another aspect of the vehicle lighting fixture with the aforementioned configuration, the reflector can have an elongated screw-insertion hole formed therein, and the bracket can include a screw boss formed therein. The vehicle lighting fixture can further include a screw to be inserted to the elongated screw-insertion hole, and can be configured such that the reflector can be fixed to the bracket by screwing the screw into the screw boss of the bracket.

With the vehicle lighting fixture having the aforementioned configuration, since the screw inserted into the screw-insertion hole of the reflector can be screwed into the screw boss of the bracket after the reflector is rotated for optical axis adjustment, the reflector can be reliably fixed to the bracket.

### BRIEF DESCRIPTION OF DRAWINGS

These and other characteristics, features, and advantages of the presently disclosed subject matter will become clear from the following description with reference to the accompanying drawings, wherein:

FIG. 1 is a vertical cross-sectional view of a conventional vehicle lighting fixture proposed in Japanese Patent Application Laid-Open No. 2014-063603;

FIG. 2 is a perspective view of essential parts of a vehicle lighting fixture made in accordance with principles of the presently disclosed subject matter;

FIG. 3 is an exploded perspective view of the essential parts of the vehicle lighting fixture of FIG. 2;

FIG. 4 is a front view of the essential parts of the vehicle lighting fixture of FIG. 2;

FIG. 5 is a top plan view of the essential parts of the vehicle lighting fixture of FIG. 2;

FIG. 6 is a cross-sectional view of the vehicle lighting fixture taken long line A-A in FIG. 4;

FIG. 7 is a cross-sectional view of the vehicle lighting fixture taken long line B-B in FIG. 5; and

FIG. 8 is a perspective view illustrating how the vehicle lighting fixture is assembled.

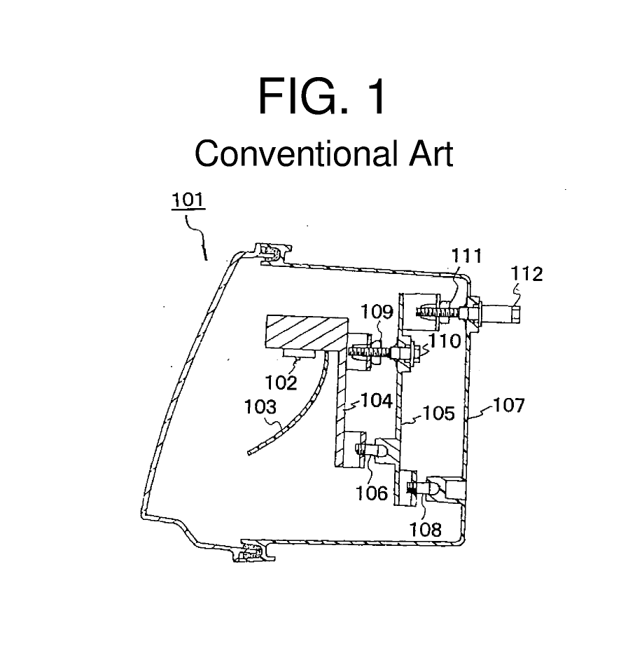

### DESCRIPTION OF EXEMPLARY EMBODIMENTS

A description will now be made below to a vehicle lighting fixture of the presently disclosed subject matter with reference to the accompanying drawings in accordance with exemplary embodiments.

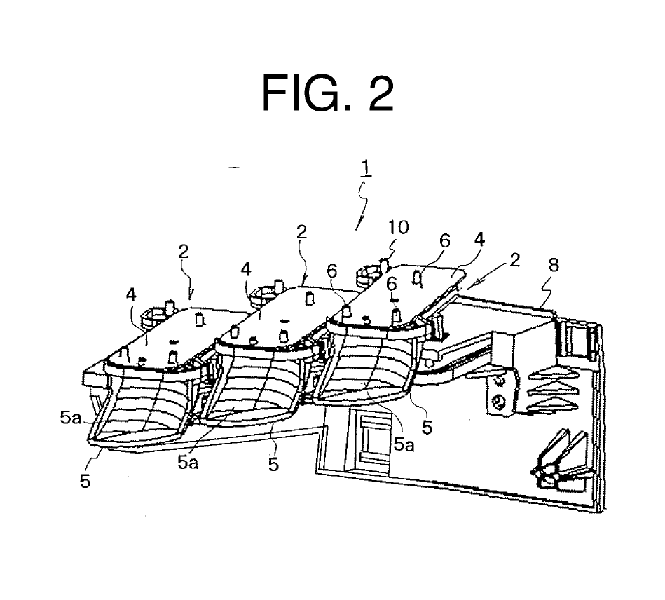

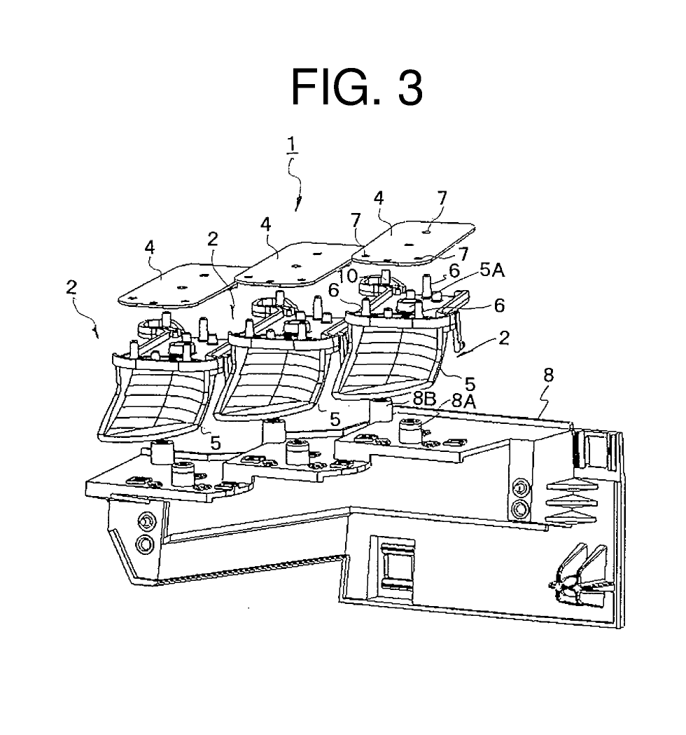

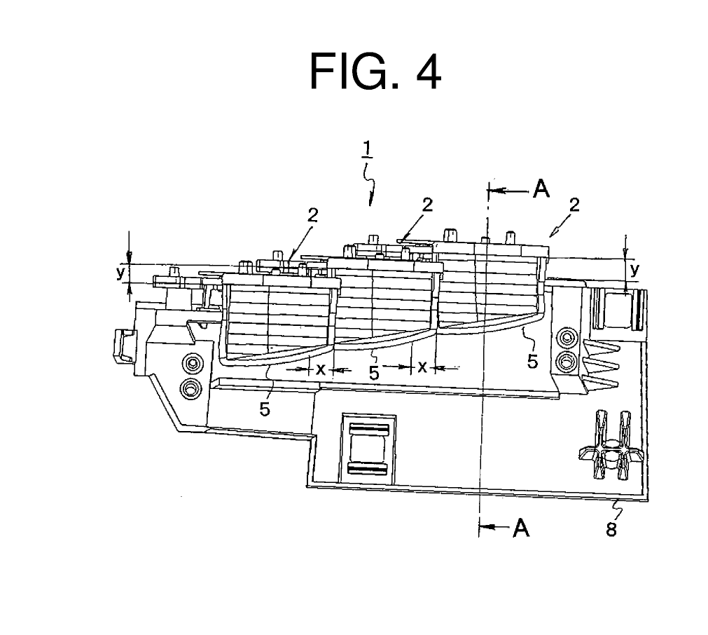

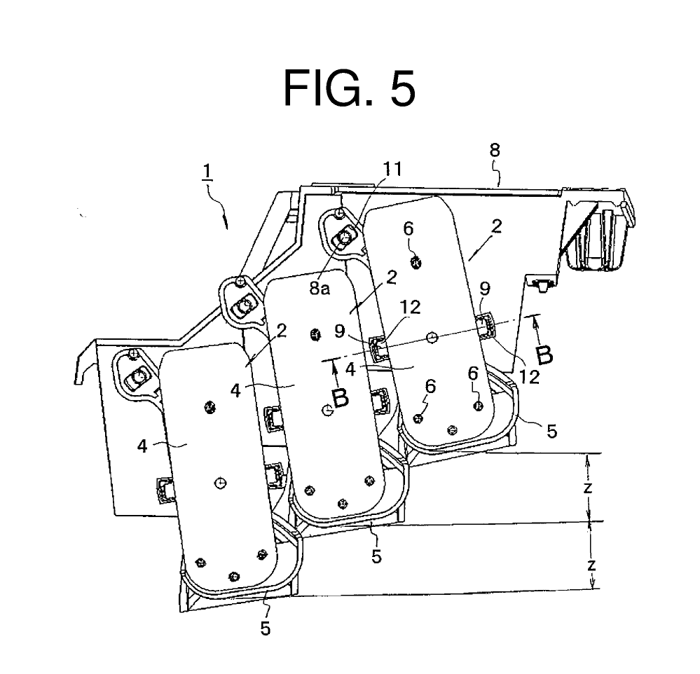

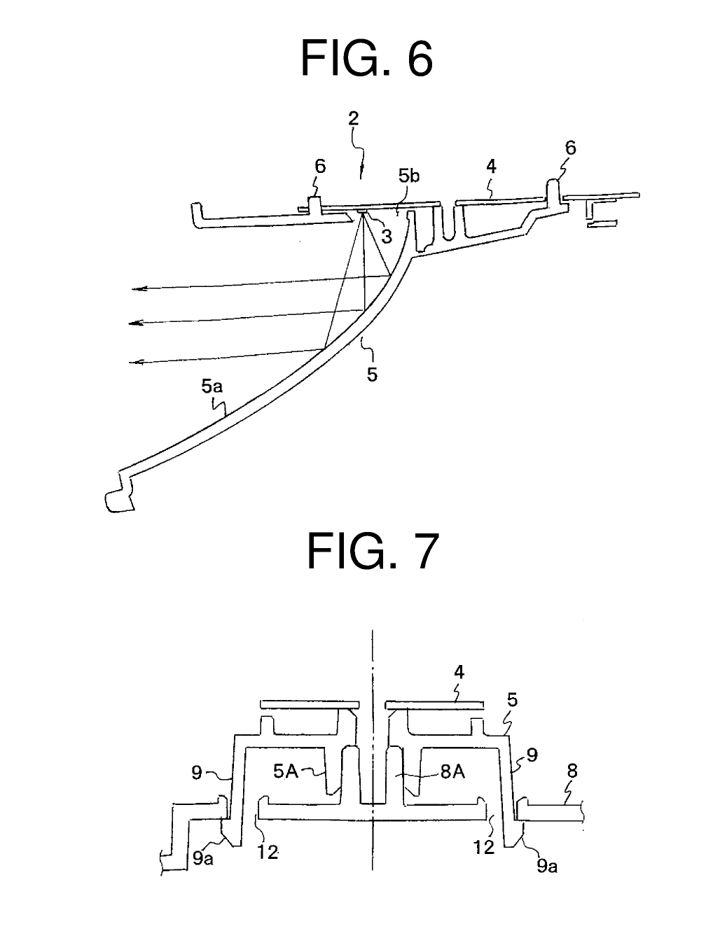

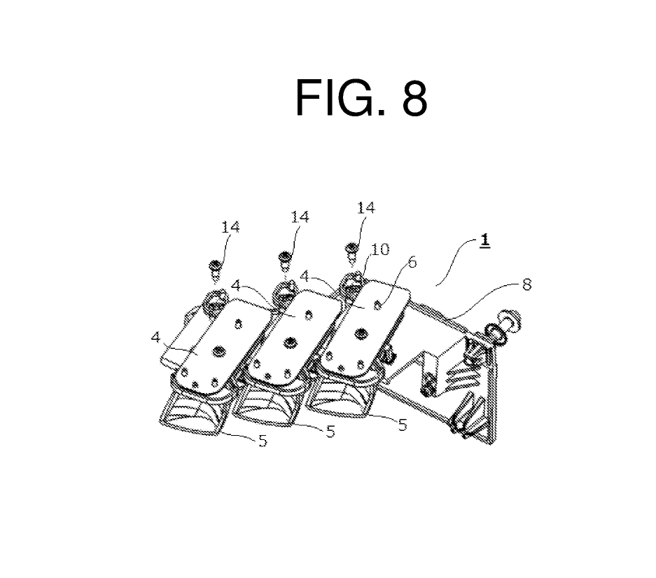

FIG. 2 is a perspective view of essential parts of a vehicle lighting fixture 1 made in accordance with the principles of the presently disclosed subject matter; FIG. 3 is an exploded perspective view of the essential parts of the vehicle lighting fixture 1 of FIG. 2; FIG. 4 is a front view of the essential parts of the vehicle lighting fixture 1 of FIG. 2; FIG. 5 is a top plan view of the essential parts of the vehicle lighting fixture 1 of FIG. 2; FIG. 6 is a cross-sectional view of the vehicle lighting fixture 1 taken long line A-A in FIG. 4; FIG. 7 is a cross-sectional view of the vehicle lighting fixture 1 taken long line B-B in FIG. 5; and FIG. 8 is a perspective view illustrating how the vehicle lighting fixture 1 is assembled.

The vehicle lighting fixture 1 according to this exemplary embodiment can be used as a headlight to be disposed on either side of a vehicle front portion. Since the headlights to be disposed on the right side and the left side can have the same basic configuration in a symmetric manner, the following description will deal with one of the headlights.

The vehicle lighting fixture 1 according to this exemplary embodiment can include a low-beam lighting unit and a high-beam lighting unit, which are not illustrated in the drawings, and three ADB (Adaptive Driving Beam) lighting units 2, which can be arranged in line in the horizontal direction as illustrated in FIGS. 2 to 5. Here, the low-beam lighting unit can form a passing-by light distribution pattern (low-beam light distribution pattern) against an oncoming vehicle, and the high-beam lighting unit can form a driving light distribution pattern (high-beam (HB) light distribution pattern). The ADB lighting units 2 can form a controlled light distribution pattern by a so-called ADB control such that the lighting unit can project light more sideward and outward than the high-beam light distribution pattern when the high-beam lighting unit is turned on while the ADB lighting units 2 can be controlled to be turned off in accordance with the surrounding conditions of the vehicle body on which the vehicle lighting fixture is installed. The three ADB lighting units 2 arranged in line in the horizontal direction as illustrated in FIGS. 2 to 5 each can be a reflective lighting unit. They can be housed in a lighting chamber that can be defined by a not-illustrated housing and a not-illustrated outer lens configured to cover the front opening of the housing.

Each of the ADB lighting units 2 can include an ADB reflector 5 and a bracket 8. The ADB reflectors 5 of the three ADB lighting units 2 can be disposed side by side. Each of the ADB lighting units 2 can include a rectangular planar substrate 4 on top of the ADB reflector 5. On the lower surface of the substrate 4, there can be mounted a light emitting diode (LED) 3 as a light source so that its light emission direction is directed downward. Although not illustrated, a high-beam reflector (HB reflector) can be provided to the high-beam lighting unit.

In each of the ADB lighting units 2, the substrate 4 can be fixed to the top surface of the ADB reflector 5 while being positioned in place. Specifically, as illustrated in FIGS. 2 to 6, the ADB reflector 5 can have positioning pins 6 that are integrally formed at three locations of the top surface of the ADB reflector 5. The substrate 4 can include circular positioning holes 7 at three locations of the substrate 4 corresponding to the three locations of the positioning pins 6 of the ADB reflector 5. Accordingly, when the substrate 4 is mounted on the top surface of the ADB reflector 5 while the three positioning pins 6 erected on the top surface of the ADB reflector 5 are fit to the corresponding positioning holes 7 formed in the substrate 4, the substrate 4 can be precisely positioned on the top surface of the ADB reflector 5. At that time, an adhesive having a high heat conductivity can be used to bond the substrate 4 to the top surface of the ADB reflector 5. In this manner, the substrate 4 can be secured while it is precisely positioned with respect to the ADB reflector 5. Other fixation methods than the adhesive bonding may include screwing, heat caulking, and the like.

Here, each of the ADB reflectors 5 can be integrally molded with a resin to have a paraboloidal reflecting surface 5a. Then, as illustrated in FIG. 6, there can be formed an opening portion 5b in a part of the top wall of each of the ADB reflectors 5 so that light emitted downward from the LED 3 can pass. The ADB reflector 5 can have a reflecting surface 5a to which an aluminum deposition treatment (reflection treatment) has been subjected.

The bracket 8 can be integrally molded by a resin to have a rectangular frame shaped top surface. Each of the ADB reflectors 5 can be rotatably held on the top surface of the bracket 8 so that the ADB reflector 5 can rotate around an axis (vertical axis) parallel to the optical axis of the LED 3. Specifically, as illustrated in FIGS. 3 and 7, each of the ADB reflectors 5 can have a top wall at the center of which a cylindrical shaft receiving part 5A can be integrally formed while projecting downward.

Furthermore, the bracket 8 can include a cylindrical boss 8A integrally formed in a top surface of the bracket 8 while being erected therefrom. When the ADB reflector 5 is attached to the bracket 8, the shaft receiving part 5A of the reflector 5 can be fit from above to the outer periphery of the cylindrical boss 8A, so that the ADB reflector 5 can be rotatably held on top surface of the bracket 8 so that the ADB reflector can horizontally rotate around the boss 8A on the top surface of the bracket 8.

Then, as illustrated in FIGS. 3, 5, and 7, on either side of each of the ADB reflectors 5, an engaging member 9 such as a hook can be integrally formed to be bent in an inverted L-letter shape. The hook 9 can have an engaging claw 9a formed at its tip end. Furthermore, as illustrated in FIGS. 3 and 5, the ADB reflector 5 can have an operation pin 10 and an arc-shaped screw-insertion hole 11 formed in a rear end side portion of the ADB reflector 5.

On the other hand, as illustrated in FIGS. 5 and 7, at right and left portions on the top surface of the bracket 8 where each of the ADB reflectors 5 is held (at two locations corresponding to the hooks 9 formed on the right and left sides of the ADB reflector 5), there can be formed elongated guide holes 12. Further, as illustrated in FIG. 3, the bracket 8 can include a screw boss 8B on the top surface of the bracket 8 on the deeper side where the ADB reflector 5 is held (where the screw-insertion hole 11 of the ADB reflector 5 is formed). There can be formed a screw hole 8a at the center of the screw boss 8B.

Thus, when the ADB reflector 5 is attached to the bracket 8, the right and left hooks 9 of the ADB reflector 5 can be inserted from above into the respective guide holes 12 of the bracket 8 so that the respective engaging claws 9a of the hooks 9 can be engaged with the guide holes 12 as illustrated in FIG. 7. In this manner, the ADB reflector 5 can be horizontally rotated in any directions around the boss 8A of the bracket 8 as a center within a range where the respective hooks 9 can be moved within the elongated guide holes 12.

When the vehicle lighting fixture 1 with the aforementioned configuration is energized to supply the LED 3 and the like of the respective lighting units 2 and others with a current from a not-illustrated power source, the LED 3 can emit light downward as illustrated in FIG. 6. The light emitted downward from the LED 3 can be reflected by the reflecting surface 5a of the ADB reflector 5 to be directed forward (leftward in FIG. 6), so that the light can be projected forward through a not-illustrated outer lens to form an ADB light distribution pattern in front of a vehicle body. Also, a not-illustrated LED of the high-beam lighting unit can emit light to be reflected by the HB reflector, thereby projecting the light forward to form an HB light distribution pattern in front of the vehicle body. In this manner, the vehicle lighting fixture 1 can function as a headlight.

In the vehicle lighting fixture 1 according to this exemplary embodiment, each of the ADB reflectors 5 can be held rotatably around the boss 8A of the bracket 8. Accordingly. the rotation of each of the ADB reflectors 5 with respect to the corresponding bracket 8 around the boss 8A as a center can achieve the adjustment of the optical axis of the LED 3 of each of the ADB lighting units 2. Therefore, the ADB light distribution pattern projected sideward can be finely adjusted with respect to the HB light distribution pattern. Specifically, the distance between the HB light distribution pattern and each of the ADB light distribution patterns and also the distance between the ADB light distribution patterns can be finely adjusted. The optical axis adjustment of the respective lighting units 2 can be achieved by the operation of the operation pin 10 provided to each of the ADB reflectors 5 on the deeper side so that each of the ADB reflectors 5 can be rotated around the boss 8A of the bracket as a center.

After completion of the optical axis adjustment of the respective lighting units 2, a screw 14 to be inserted into the screw-insertion hole of the ADB reflector 5 as illustrated in FIG. 8 can be screwed into the screw hole 8a of the screw boss 8B formed on the deeper side in the top surface of the bracket 8 (see FIG. 5), to thereby fix each of the ADB reflectors 5 to the bracket 8. At this time, as illustrated in FIG. 7, since the engaging claws 9a of the right and left engaging members (hook) 9 formed in the ADB reflector 5 can be engaged with the guiding holes 12 formed in the bracket 8, the ADB reflector 5 can be reliably prevented from dropping off the bracket 8.

As discussed above, in the vehicle lighting fixture 1 having the aforementioned configuration, each of the ADB the reflectors 5 arranged side by side in the lateral direction can be held while being rotatable relative to the bracket 8 around the boss 8A thereof (the axis parallel to the optical axis of the LED 3). Therefore, the optical axis of each of the ADB lighting units 2 can be adjusted without use of various additional parts such as an adjustment nut and an adjustment bolt. As a result, the vehicle lighting fixture 1 can reduce the parts number to thereby reduced the parts cost as well as achieve weight reduction.

Furthermore, in this exemplary embodiment, since the engaging claws 9a of the hooks 9 formed in each of the ADB reflectors 5 can be engaged with the corresponding guiding hole 12 formed in the bracket 8 as illustrated in FIG. 7, each of the ADB reflectors 5 can be prevented from dropping off the bracket 8 while the rotation of the ADB reflector 5 can be allowed to achieve the optical axis adjustment.

In the aforementioned exemplary embodiment, the vehicle lighting fixture is applied to a headlight, but may be applied to a low-beam lighting unit, a high-beam lighting unit, and other lighting units for use in various applications. Furthermore, the low-beam, high-beam, and ADB lighting units in this exemplary embodiment are arranged side by side in the lateral direction, but may be appropriately arranged in accordance with the necessary specification. The number of the ADB lighting units 2 is not limited to three, and may be two or four or more.

It will be apparent to those skilled in the art that various modifications and variations can be made in the presently disclosed subject matter without departing from the spirit or scope of the presently disclosed subject matter. Thus, it is intended that the presently disclosed subject matter cover the modifications and variations of the presently disclosed subject matter provided they come within the scope of the appended claims and their equivalents. All related art references described above are hereby incorporated in their entirety by reference.

What is claimed is:

1. A vehicle lighting fixture comprising:
a light source having an optical axis;
a reflector configured to hold the light source; and
a bracket configured to hold and fix the reflector so that the reflector can rotate around an axis parallel to the optical axis of the light source.

2. The vehicle lighting fixture according to claim 1, wherein the reflector includes an engaging member, and the bracket has a guiding hole formed therein, so that the engaging member is engaged with the guiding hole.

3. The vehicle lighting fixture according to claim 1, wherein:
the reflector has an elongated screw-insertion hole formed therein;
the bracket include a screw boss formed therein;
the vehicle lighting fixture further comprises a screw to be inserted to the elongated screw-insertion hole, and is configured such that the reflector can be fixed to the bracket by screwing the screw into the screw boss of the bracket.

4. The vehicle lighting fixture according to claim 2, wherein:
the reflector has an elongated screw-insertion hole formed therein;
the bracket include a screw boss formed therein;
the vehicle lighting fixture further comprises a screw to be inserted to the elongated screw-insertion hole, and is configured such that the reflector can be fixed to the bracket by screwing the screw into the screw boss of the bracket.
